(19) United States
(12) Patent Application Publication
(10) Pub. No.: US 2026/0089368 A1
(43) Pub. Date: Mar. 26, 2026

(54) VIDEO TRANSFORMATION TECHNIQUES

(71) Applicant: GOOGLE LLC, Mountain View, CA (US)

(72) Inventors: Zhixian Yu, Mountain View, CA (US); Bo Hu, Sunnyvale, CA (US); Chun-Te Chu, Bellevue, WA (US); Ramin Mehran, Kirkland, WA (US); Yukun Zhu, Kirkland, WA (US); Ying Ding, Los Altos, CA (US); Shushan Chen, Mountain View, CA (US); Jiashi Cao, Los Altos, CA (US); Sudheendra Vijayanarasimhan, La Canada Flintridge, CA (US)

(21) Appl. No.: 19/340,309

(22) Filed: Sep. 25, 2025

Related U.S. Application Data
(60) Provisional application No. 63/699,618, filed on Sep. 26, 2024.

(51) Int. Cl. H04N 21/81; H04N 21/44; H04N 21/845

(52) U.S. Cl. CPC H04N 21/816; H04N 21/44016; H04N 21/8456

(57) ABSTRACT

A method includes segmenting a source video into source video segments, and generating a script for a new video using a generative artificial intelligence (AI) engine. The script includes, for each of one or more new video segments arranged according to a sequential order, a segment descriptor and a segment voice-over transcript. For each new video segment, a voice-over segment is generated from among the source video segments based on the respective segment voice-over transcript, and a set of source video segment(s) is selected based on the respective segment descriptor, for use in generating the new video segment. The method also includes generating the new video, at least in part by inserting the generated voice-over segments for the new video segment(s), and the selected set(s) of source video segment(s) for the new video segment(s), in accordance with the sequential order.

### CROSS-REFERENCE TO RELATED APPLICATION

This application claims the benefit of U.S. provisional patent application No. 63/699,618, filed Sep. 26, 2024, the entire disclosure of which is hereby incorporated herein by reference.

### FIELD OF TECHNOLOGY

The present disclosure relates to digital video transformation (e.g., editing, trimming, supplementing, etc.) techniques and, more particularly, to techniques for using generative artificial intelligence and/or other models to create new videos from source videos.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

In some contexts, it can be desirable to shorten or otherwise modify videos. For example, certain platforms may not allow uploads or downloads of videos over a certain length. In other contexts, shorter videos may be desirable for other reasons. In digital advertising, for example, shorter versions of video advertisements often, if judiciously edited, have a greater impact on viewers than the longer versions, resulting in improved performance metrics (e.g., higher click-through rates, higher conversion rates, etc.). More generally, it can be desirable to modify videos (shorten, rearrange, etc.) so as to improve performance or meet other desired criteria. For example, arranging a video advertisement such that it focuses more (e.g., includes in an opening and/or final sequence) on a particular product or service can increase the probability that a viewer will remember the product or service after watching the video.

Editing videos with video editing software tools, however, can be very time-consuming, particularly in contexts where there is a need to edit many (e.g., thousands or millions) of videos. In recent years, significant progress has been made in the field of automated digital content generation and modification. In particular, generative artificial intelligence (AI) models have begun to find widespread use in both personal and commercial domains for creating or modifying text, images, and video. However, using such models to edit digital content can, in the absence of granular and time-consuming guidance via software tools, result in lower quality videos (e.g., confusing, nonsensical, jarring, and/or ineffectual sequences of video segments), which can in turn lead to measurably poor performance (e.g., low click-through rates, low conversion rates, etc.).

### SUMMARY

In the disclosed techniques, a system generates new videos based on source videos. As the terms are used herein, and unless the context of use clearly indicates otherwise, generating or creating a “new” video based on or from a source video, is also referred to as “editing” or “transforming” the source video, and vice versa, regardless of how many components or aspects of the source video are retained in the new video, and regardless of whether any components or aspects of the new video are precisely identical to those of the source video (e.g., regardless of whether the new video exactly replicates any portions/frames/pixels of the source video).

In a first aspect of the disclosed techniques, a system determines that a source video is associated with one or more components (e.g., an audio component, or more specifically a speech component, etc.), and identifies a starting segment of the source video based at least in part on that determination. For example, the system may select a large language model (LLM) or other generative artificial intelligence (AI) model, from among multiple candidate models, in response to determining that the source video has a speech component capable of transcription (e.g., a voice-over in the source video). The system then generates the new video using one or more portions of the source video, at least in part by generating an initial segment of the new video based on the identified source starting segment. In some implementations, the system generates the new video such that the new video starts with the identified segment of the source video, and then plays through the end of the source video. By selecting a particular segment identification model based at least in part on which component or components are associated with the source video, the disclosed techniques can ensure that a segment of the source video (e.g., one that is more impactful, attention-grabbing, etc., and therefore better performing) can be identified for use as the starting segment of the new video. Moreover, in implementations where the new video begins at the source starting segment and continues in the original sequence until the end of the source video, the system can select the new starting segment while ensuring that the time sequence of the source video is preserved. This in turn can preserve the integrity of the timeline and accurately capture the chronological progression of depicted events as presented in the source video. Stated differently, these techniques can better preserve the context, flow, narrative, etc., of the source video.

In some cases, however, such techniques can fail to maximize (or sufficiently maintain or improve, etc.) the quality or performance of the new video relative to the source video. For example, choosing a new starting segment within the source video, while preserving the remaining sequence of the source video, might result in a new video that fails to adequately convey (and/or fails to improve upon) certain aspects of the source video, such as the story line or plot, a product or service being advertised, a call to action, etc., and therefore has poor performance metrics.

Thus, in a second aspect of the disclosure, a system also, or instead, modifies the flow/sequence of audio segments of the source video (e.g., music, sound effects, voice-over, etc.) relative to the video frame segments. In particular, in a second aspect of the disclosure, a system uses a generative AI model (e.g., an LLM) to generate video segment text descriptors that each correspond to a different video frame segment of the source video, and uses the segment text descriptors to map one or more audio segments of the source video to one or more alternative/different video frame segments of the source video (i.e., to segment(s) other than those that had originally corresponded to the audio segments in the source video). The system then generates the new video based at least in part on the video-to-audio mapping. By generating and using such a mapping, and by basing the mapping upon AI-generated text descriptors of the video frame segments, the system can avoid pairing audio to video frames in a manner that causes poor sequencing/flow, unclear action calls, and so on, and can therefore avoid degraded performance metrics. This can be particularly useful when shortening the source video, as shortened videos tend to suffer from degradations of this sort.

In a third aspect of the disclosure, a system can provide still greater flexibility while mitigating quality/performance degradations of the sort noted above. In particular, the third aspect can generate a new script (e.g., scene descriptions and voice-over transcript) for the new video, e.g., based on the source video and/or specific user criteria such as video duration and/or other requested/desired video characteristics. The new script may specify a new flow and/or content of the video, as well as a new voice-over transcript. For example, the new video may be scripted to provide a more compelling introduction, a more interesting perspective on the video content, better flow, clearer action calls, etc., without severe degradations (and possibly with improvements) to the quality or performance metrics of the new video. The source video is segmented into different scenes, shots, or other suitable units of video, and some or all of the resulting source video segments are mapped to segments (e.g., scenes) of the new video as represented by the generated script. That is, a set of one or more source video segments is selected (e.g., by a generative AI model) for use in generating each new video segment. This ensures some level of fidelity to the source video, which may reflect desired brand guidelines, cinematic preferences, and/or other factors or characteristics, and can help reduce the risk of hallucination by bounding the creative space for the generative AI process when creating the new video. Further, the mapping process can pair specific source video segments to the new video segments and voice-over in a manner that avoids poor sequencing/flow, unclear action calls, and so on, and therefore avoids degraded performance metrics.

Other advantages will also become apparent to one of ordinary skill in the art upon reading this disclosure and viewing the corresponding drawings.

### BRIEF DESCRIPTION OF THE DRAWINGS

FIG. 1 is a block diagram of an example system in which one or more video transformation techniques of the present disclosure can be implemented.

FIGS. 2A-2F depict example video transformation schemes that may be implemented by the computing system of FIG. 1.

FIG. 3A depicts an example process for transforming a source video into a new video according to the first aspect of the present disclosure, which may be implemented by the computing system of FIG. 1.

FIG. 3B depicts an example process for transforming a source video into a new video according to the third aspect of the present disclosure, which may be implemented by the computing system of FIG. 1.

FIG. 3C depicts an example language model-based architecture for implementing the process of FIG. 3B with iterative tuning, according to one implementation.

FIG. 4 is a flow diagram of an example method for transforming a source video into a new video according to the first aspect of the present disclosure.

FIG. 5 is a flow diagram of an example method for transforming a source video into a new video according to the second aspect of the present disclosure.

FIG. 6 is a flow diagram of an example method for transforming a source video into a new video according to the third aspect of the present disclosure.

### DETAILED DESCRIPTION OF THE DRAWINGS

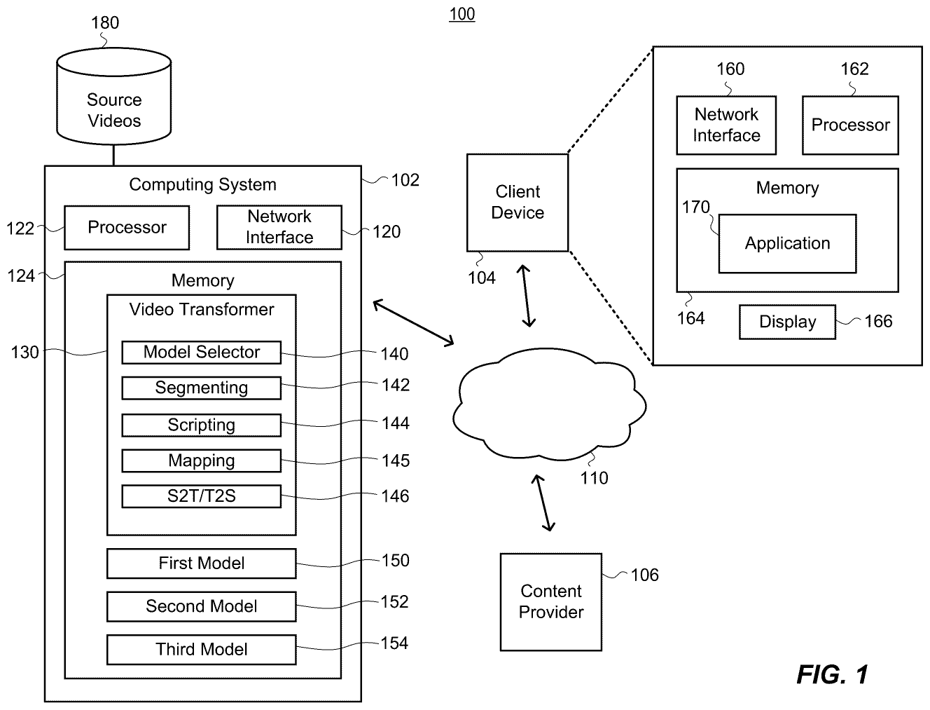

FIG. 1 is a block diagram of an example system 100 in which techniques for video transformation can be implemented. The example system 100 includes a computing system 102, a client device 104, a content provider 106 (e.g., a server of a content provider), and a network 110. The computing system 102 is remote from the client device 104 and content provider 106, and is communicatively coupled to the client device 104 and content provider 106 via the network 110. In some implementations, however, the system 100 does not include client device 104 and/or content provider 106.

The network 110 may be a single communication network (e.g., the Internet), and in some implementations also includes one or more additional networks. As just one example, the network 110 may include a cellular network, the Internet, and a server-side local area network (LAN). While FIG. 1 shows only a single client device 104 and single content provider 106, it is understood that the computing system 102 may also be in communication with a number (e.g., thousands or millions) of other client devices that are generally similar to the client device 104, and/or in communication with a number (e.g., hundreds or thousands) of other content providers that are generally similar to content provider 106.

Generally, computing system 102 can perform video generation/transformation services (e.g., for providers such as content provider 106). In a digital advertising context, for example, computing system 102 may use one or more existing videos from content providers such as content provider 106 to generate new videos that the content provider can use in future digital advertising. In one such example, the new/additional videos can be used to provide a greater diversity of videos/advertisements, and/or to provide better performing videos/advertisements (e.g., as measured based on impression rate, click-through rate, conversion rate, etc.).

As another example, computing system 102 may generate new videos that are intended to facilitate viewer understanding (e.g., videos for instructional materials), where performance is measured by way of determining what proportion of viewers take the correct actions upon viewing the videos. Other contexts are also possible. For case and consistency of explanation, however, this disclosure primarily uses examples that relate to a digital advertising implementation/context.

The client device 104 is generally configured to access information resources (e.g., web pages and/or user interfaces of mobile applications or other applications) that can present the videos generated by computing system 102. For example, computing system 102 may generate digital video advertisements and then server (or another computing system may then serve) the digital advertisements to users of client device 104 and/or other similar client devices using suitable techniques, such as conducting auctions (e.g., auctions based on keyword bids by advertisers, relevancy metrics, etc.). The digital advertisements may be served in slots of web pages visited by the users, and/or slots of application user interfaces displayed to the users, etc.

The content provider 106 generally may commission or request that computing system 102 generate one or more videos, and/or may provide the source video(s) upon which the video generation is based. For example, content provider 106 may be a digital advertiser who provides a digital advertisement video for each of a number of offered products or services, as part of one or more advertising campaigns owned or managed by content provider 106.

The computing system 102 includes a network interface 120, a processor 122, and memory 124. The network interface 120 includes hardware, firmware, and/or software configured to enable the computing system 102 to exchange electronic data with the client device 104 and other, similar client devices (and possibly content provider 106, etc.) via the network 110. For example, the network interface 120 may include a wired or wireless router and a modem. The processor 122 may be a single processor (e.g., a central processing unit (CPU)), or may include multiple processors (e.g., multiple CPUs, or one or more CPUs and one or more graphics processing units (GPUs)). Computing system 102 may be a single computing device (e.g., server) at a single location, or may include multiple, coordinating computing devices that are either co-located or remotely distributed.

The memory 124 is a computer-readable, non-transitory storage medium, unit, or device, or collection of such media/units/devices, and may include persistent and/or non-persistent memory components. The memory 124 stores instructions executable by processor 122 to perform various operations, including the instructions of various software applications and the data generated and/or used by such applications. In the example system 100 of FIG. 1, memory 124 stores the instructions of a video transformer 130, which includes a model selector module 140, a segmenting module 142, a scripting module 144, a mapping module 145, and a speech-to-text (S2T)/text-to-speech (T2S) module 146. The operations of these modules are discussed in greater detail below.

Generally, however, model selector module 140 is configured to select a particular model or models, from among multiple candidate models (e.g., models 150, 152, 154), in order to identify a starting segment in a source video. In the first aspect of the disclosure, the selection is based at least in part on one or more components (e.g., audio, or speech specifically, etc.) being associated with the source video.

Segmenting module 142 is generally configured to divide a source video into discrete video segments (e.g., by using a neural network, another machine learning model, and/or rules/algorithms to identify natural scene breaks), or to identify segment dividers/markers by analyzing metadata (e.g., time stamps). In various implementations, the segmenting module 142 may segment the source video into scenes, shots (e.g., perspectives, such as or similar to camera shots), fixed-duration units (e.g., two-second segments of video), or other suitable units.

Scripting module 144 is generally configured to use one or more generative AI models (e.g., LLM(s) or multimodal LLM(s)) to generate text descriptions of, or for, videos and/or particular segments of videos, depending on the implementation and/or aspect. In some implementations of the second aspect, for example, the scripting module 144 generates text descriptors of the segments of the source video. As another example, in some implementations of the third aspect, the scripting module 144 generates text scripts describing scenes of a yet-to-be-generated new video, along with transcripts for the corresponding voice-overs.

Mapping module 145 is generally configured to select particular source video segments for insertion/inclusion (possibly after post-processing and/or modification) at particular positions within the yet-to-be-generated (or at least, yet-to-be-finalized) new video. In some implementations (e.g., in the first aspect), mapping module 145 uses the model selected by model selector module 140 to identify/select a particular (e.g., “best” according to some criteria or goal) segment in a source video for use as a starting segment in the new video. In other implementations (e.g., in the third aspect), mapping module 145 maps particular source video segments to particular new video segments (e.g., to particular scenes in the new video script, as represented by text descriptors of those scenes). The source video segments and new video segments may or may not have a one-to-one correspondence, depending on the implementation. For example, mapping module 145 may map shots of a source video to scenes of a new video script, or may map scenes of a source video to scenes of a new video script, and so on.

S2T/T2S module 146 is generally configured to provide one or both of S2T and T2S functionality, either by including such functionality locally at computing system 102 or by remotely accessing a server that provides such functionality. In other implementations, computing system 102 receives speech transcripts from other sources (e.g., content provider 106).

As the terms are used herein, a “segment” or “video segment” can refer to a particular set of consecutive frames of a video, with or without corresponding audio depending on the context of the discussion or the implementation. A “video frame segment” more specifically refers to a particular set of consecutive frames of a video without corresponding audio. An “audio segment” specifically refers to a particular portion of audio that corresponds to (aligns with), but does not itself include, a particular video frame segment.

Memory 124 can also store one or more models, such as generative artificial intelligence (AI) models. In particular, in the example system 100 of FIG. 1, memory 124 stores a first model 150, a second model 152, and a third model 154. In other implementations, the memory 124 stores more or fewer models. In particular, it is understood that any reference herein to models 150, 152, 154 (collectively) can encompass, in other implementations, only two such models, or more than three such models. Moreover, the term “generative AI engine” is used herein to generally refer to a collection of one or more generative AI models, possibly in addition to one or more other types of models. References herein to different operations using the same “generative AI engine” encompass implementations where the different operations only use different models of the generative AI engine, implementations where the different operations use the same model of the generative AI engine, and/or other combinations (e.g., a first operation using first model 150 and second model 152, and a second operation using only second model 152 or second model 152 and third model 154, etc.). In some implementations, the first model 150, second model 152, and/or third model 154 are not stored in memory 124, and instead are stored in one or more remote servers or other computing systems. For example, one or more of models 150, 152, and 154 may be remotely accessed (e.g., as a cloud service) by video transformer 130 via network 110.

As discussed below, the nature of models 150, 152, 154 can vary depending on the aspect/implementation. For example, in different aspects/implementations, the models 150, 152, 154 may include one or more LLMs (e.g., to generate and/or analyze text descriptors), one or more small language models (SLMs), and/or one or more multimodal LLMs or diffusion models (e.g., to generate, analyze, and/or modify video frames in combination with text prompts or descriptors, etc.).

It is understood that, in some implementations, memory 124 may omit one or more modules/elements shown in FIG. 1, such as model selector module 140, segmenting module 142, and/or S2T/T2S module 146. It is also understood that, in some implementations, memory 124 may include one or more additional modules/elements not shown in FIG. 1, such as modules that perform corrective operations, modules that facilitate serving images (e.g., digital advertisements) to users of devices such as client device 104, and so on.

The client device 104 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, client device 104 includes a network interface 160, a processor 162, memory 164, and a display 166. The processor 162 may be a single processor, or may include multiple processors.

Memory 164 includes one or more computer-readable, non-transitory storage media, units, or devices, which may include persistent and/or non-persistent memory components. The memory 164 stores instructions that are executable by processor 162 to perform various operations, including the instructions of various software applications and the data generated and/or used by such applications.

In the example system 100 of FIG. 1, memory 164 stores at least an application 170. Generally, application 170 is executed by processor 162 to provide one or more user interfaces via display 166, where the user interface(s) enable a user to access information resources that can include videos generated by computing system 102. For example, application 170 may be a web browser application, and videos generated by computing system 102 may be included in content slots of web pages visited by the user and presented on display 166. As a more specific example, the videos may be digital advertisements that are generated by computing system 102, and then selected and provided to client device 104 by computing system 102 (or by another computing system) for insertion in the content slots. In other implementations, application 170 is a dedicated application (e.g., a “mobile app”), and videos generated by computing system 102 are included in content slots of user interfaces that are presented by the application 170 on display 166. The computing system 102 may provide/transmit the videos to client devices such as client device 104 as streaming videos (e.g., in implementations where application 170 is a YouTube® mobile application, or is a web browser that the user of client device 104 is using to access the YouTube® website).

The display 166 includes hardware, firmware, and/or software configured to enable a user to view visual outputs of the client device 104, and may use any suitable display technology (e.g., LED, OLED, LCD, etc.). In some implementations, the display 166 is incorporated in a touchscreen having both display and manual input capabilities. Moreover, in some implementations where the client device 104 is a wearable device, the display 166 is a transparent viewing component (e.g., lenses of smart glasses) with integrated electronic components. For example, the display 166 may include micro-LED or OLED electronics embedded in lenses of smart glasses. While not shown in FIG. 1, client device 104 can also include one or more audio output devices or components such as one or more speakers (e.g., for presenting the audio that accompanies videos provided by computing system 102 or another computing system).

The network interface 160 includes hardware, firmware, and/or software configured to enable the client device 104 to exchange electronic data with the computing system 102 via the network 110. For example, the network interface 160 may include a cellular communication transceiver, a WiFi transceiver, and/or transceivers for one or more other wired and/or wireless communication technologies.

While FIG. 1 shows client device 104 as a single component communicating directly (i.e., via network 110) with the computing system 102, in some implementations the subcomponents of client device 104 shown in FIG. 1 are instead divided among two or more user-side devices. As just one example, a pair of smart glasses may include the processor 162, the memory 164, and the display 166, while a smartphone may include another processing unit, another memory, another display, and the network interface 160. The smart glasses may then communicate as needed with the smartphone (e.g., via Bluetooth) to enable the operations described herein.

Returning to the computing system 102, the video transformer 130 generally operates by obtaining a source video (e.g., by accessing a database 180, or received directly from content provider 106, etc.), and generating a new video based on that source video. The new video may be a shorter, more concise video, for example, or may be the same length or longer than the source video, depending on the aspect, implementation, and/or scenario. Moreover, the precise techniques that computing system 102 employs to generate the new video based on the source video vary depending on the aspect/implementation.

In a first aspect of the present disclosure, model selector module 140 determines one or more components with which the source video is associated, and selects a particular model (e.g., first model 150) from a set of candidate segment identification models (e.g., models 150, 152, 154, or a larger or smaller set of candidate models) based on at least one of the determined component(s). As the term is used herein, a “component” of video may be a low-level component such as an “audio component,” or a higher-level component such as a “speech component” within the audio. As another example, a “component” may be a certain type of metadata associated with the video, such as a collection of time stamps that delineate video segments.

Generally, each of the candidate models is configured to be operable by mapping module 145 to identify a particular starting segment within a source video. That is, each candidate model can process the source video (or a portion of the source video) to identify a particular starting segment. In this first aspect, each candidate model is designed to identify/select a starting segment using different techniques, and/or is designed to optimize or improve different parameters/qualities/etc. (e.g., to maximize or increase the probability of grabbing a viewer's attention, and/or to increase the probability that a user will quickly understand the purpose of the video, etc.). The mapping module 145 may more specifically identify a starting video frame segment from the source video, a starting audio segment from the source video, or a full video segment (i.e., video frames plus audio) from the source video, depending on the implementation.

In some implementations of the first aspect, the first model 150 accesses or includes a machine learning model (e.g., a separate neural network not shown in FIG. 1) that analyzes a predetermined time window of the source video to identify a starting segment. The time window may occur near the end of the source video in order to increase the chances of capturing a more important part of the source video (e.g., a call to action, a product identifier, etc.). As an example, the time window may begin and end anywhere between the last 20 seconds and the last 5 seconds of the source video. As a more precise example, the time window may begin 15 seconds from the end of the source video, and end 10 seconds from the end of the source video. Within the time window, the machine learning model analyzes the video frames (and, in some implementations, the corresponding audio) to identify a preferred starting segment.

It is to be understood that identifying a starting “segment” does not necessarily, but may, entail identifying a particular portion of the source video as defined by both a starting time and an ending time. In some implementations, for example, the mapping module 145 identifies (e.g., using model 150, 152, or 154) a starting segment by identifying only a starting time within the source video, which naturally correlates to the beginning of some arbitrary length segment/portion of the source video but does not specify an end time. In other implementations, however, identifying a starting segment includes identifying a portion of the source video with a particular, defined end time as well as the start time (e.g., in an implementation where the source video is pre-segmented or segmented by segmenting module 142 and where mapping module 145 selects a particular segment identifier).

In the above implementations where the first model 150 operates within a predetermined time window, and in some alternative implementations, the second model 152 may access or include a large language model (LLM) that analyzes a transcript of speech in the audio (but not necessarily the raw audio, and not necessarily any video frames) of the source video to identify a preferred starting segment, and/or the third model 154 may access or include a machine learning model (e.g., a neural network) that analyzes video frames and audio (but not necessarily a speech transcript) of the source video to identify a preferred starting segment.

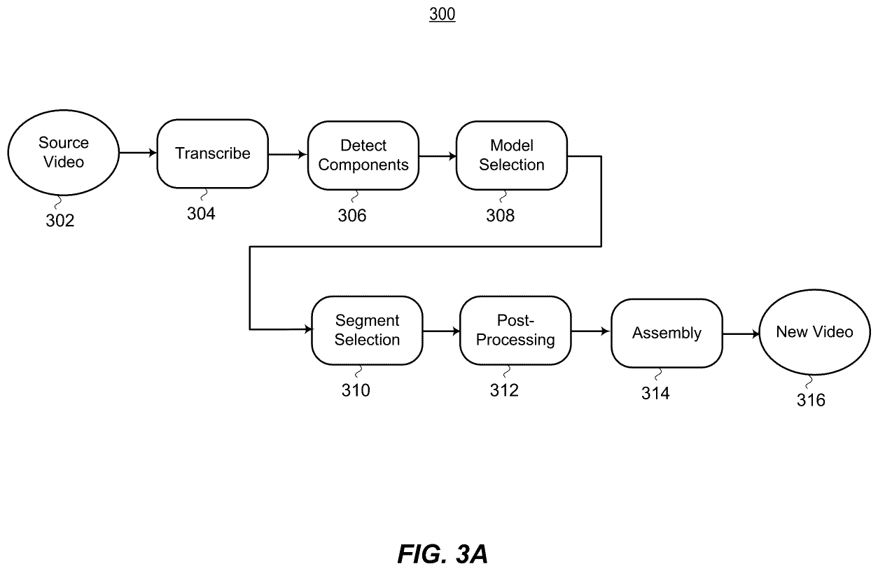

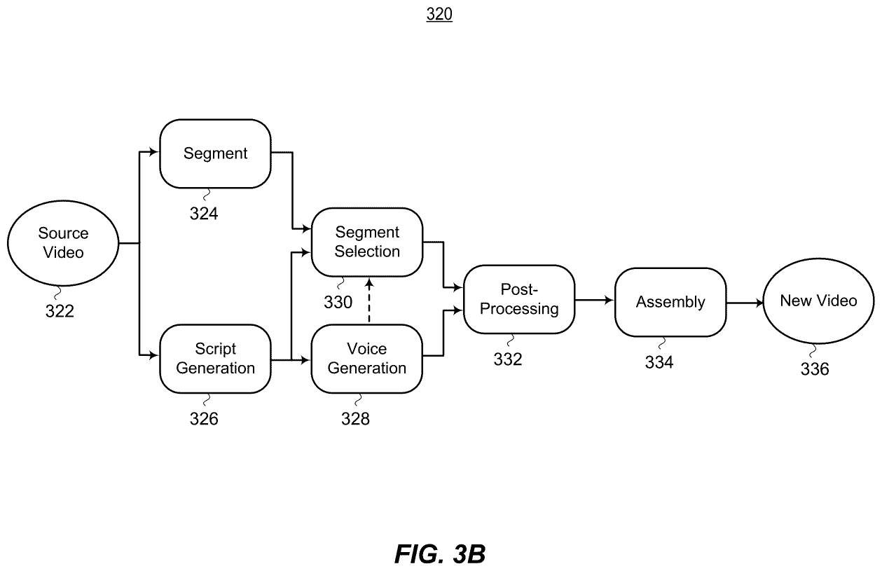

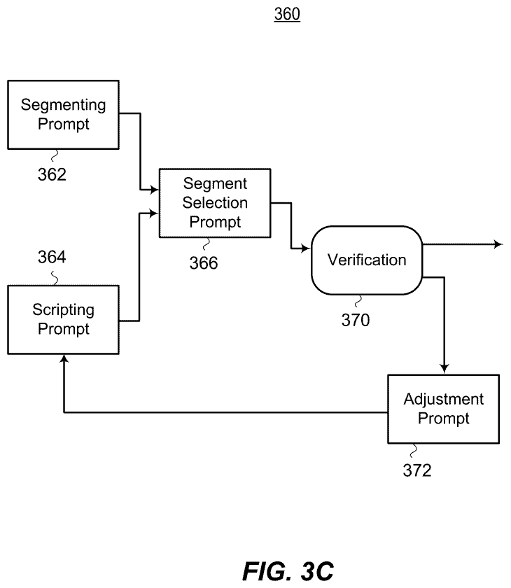

Depending on the implementation, the mapping module 145 may apply particular rules to determine which model, or models, to use to identify a starting segment in the source video. In the first aspect of the present disclosure, the rules depend at least in part on whether the source video is associated with one or more particular components. For example, the mapping module 145 may select the second model 152 as described above (e.g., an LLM) if and only if the model selector module 140 determines that the source video is associated with a speech component (or, in some implementations, only if the model selector module 140 determines that the source video is associated with an audio component that the S2T/T2S module 146 can convert to a speech component/transcript, etc.). If the source video is not associated with such a component, the mapping module 145 may instead select the first model 150 and/or the third model 154. In one implementation, for example, the mapping module 145 selects the third model 154 as a second choice, and then selects the first model 150 as a third choice if and only if the third model 154 generates an error or is otherwise unable to identify a new starting segment in the source video. Further detail on such an implementation is provided below in connection with the description of FIG. 3A.

In some implementations, the model selector module 140 determines to use two or more (e.g., all) of models 150, 152, and 154 to identify the new starting segment, with each of those selected models becoming a candidate model, i.e., a model whose output is considered as one of multiple outputs that can potentially be used by mapping module 145 as the starting segment in the new video. For example, each of models 150, 152, and 154 may be a machine learning model (e.g., LLM, neural network, etc.), and the mapping module 145 may use an additional machine learning model (e.g., another neural network not shown in FIG. 1) to predict/assess the performance of the new video (e.g., predicted click-through rate, predicted conversion rate, etc.) with each of the different candidate starting segments. The mapping module 145 may then identify the candidate starting segment that gives a video the best predicted performance as the starting segment to be used in the new video.

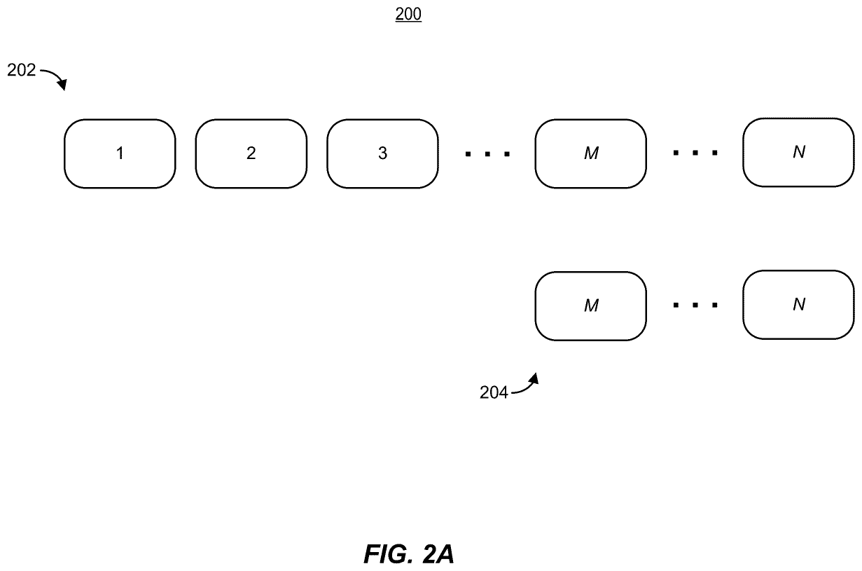

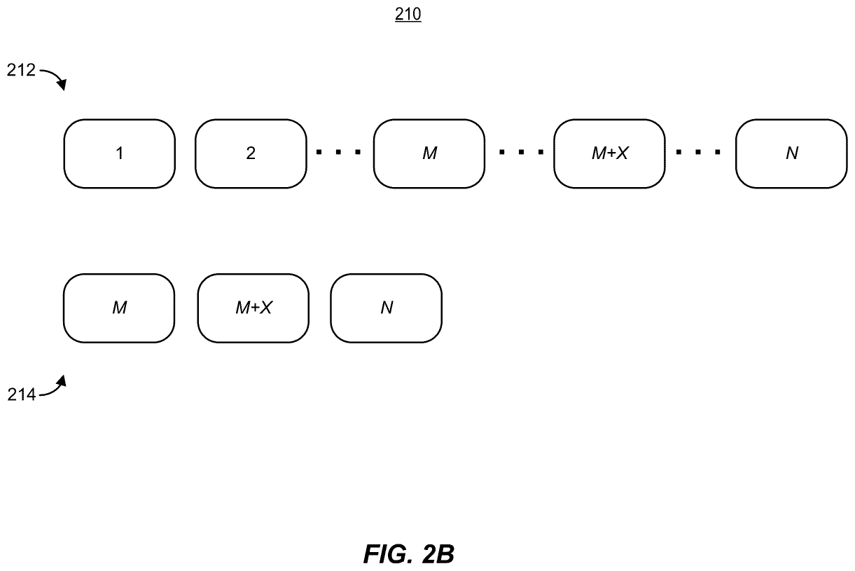

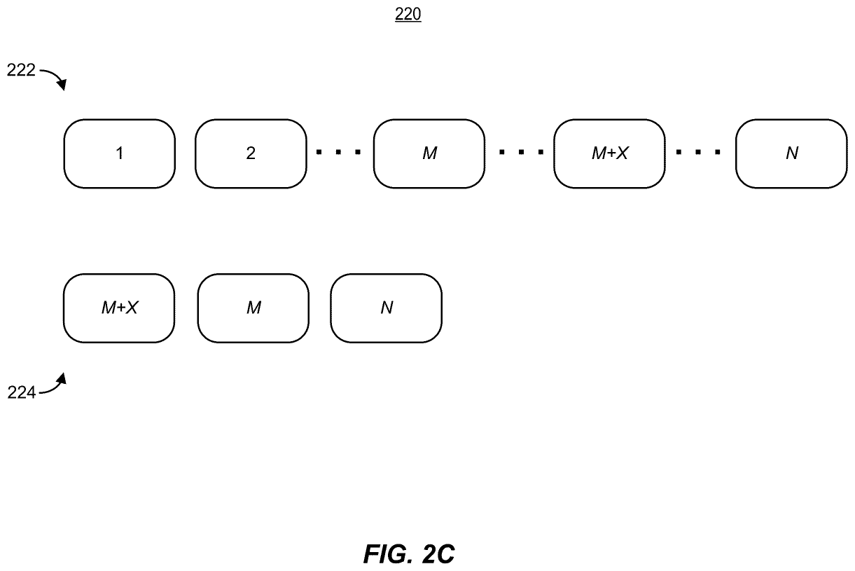

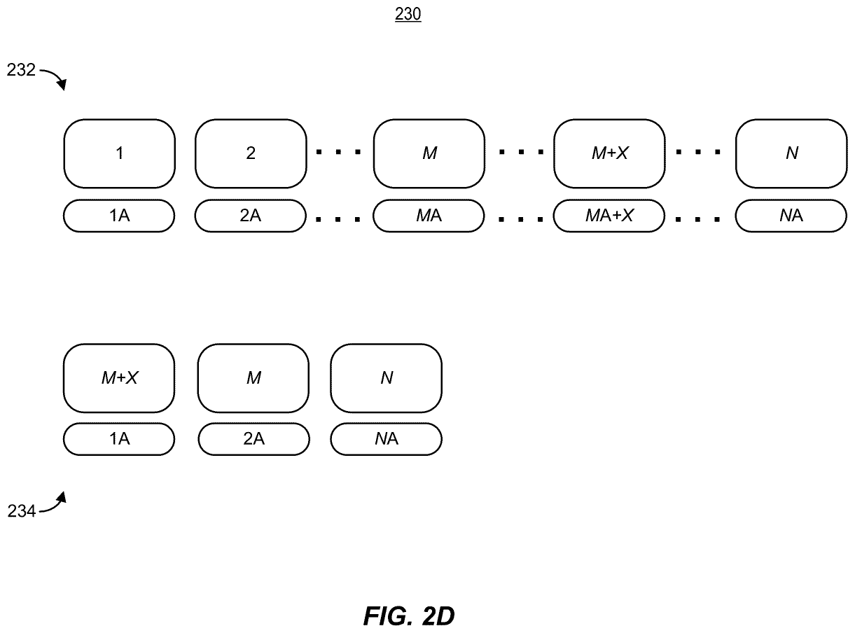

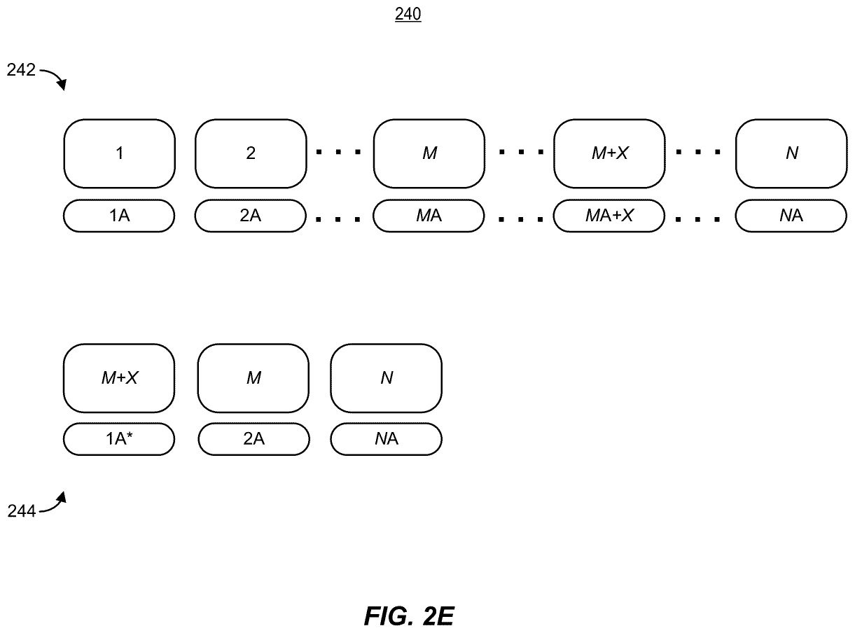

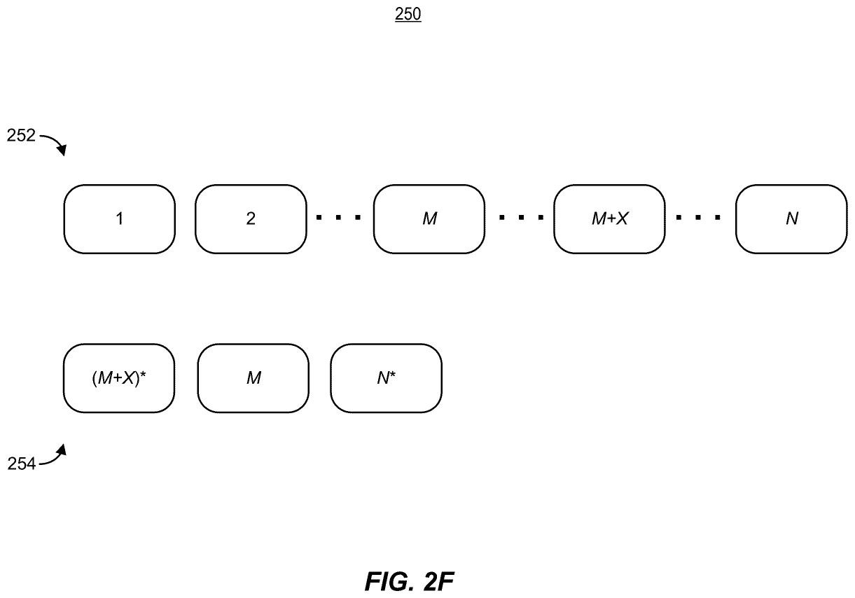

FIGS. 2A through 2F depict example video transformation schemes that may be implemented by the computing system of FIG. 1. In FIGS. 2A through 2C and 2F, each block represents a video segment or a video frame segment. In FIGS. 2D and 2E, larger blocks represent a video frame segment, and smaller blocks represent audio segments. While FIGS. 2A through 2F show all segments as being equal width (horizontally), the segments may or may not all be of equal duration depending on the implementation and/or scenario.

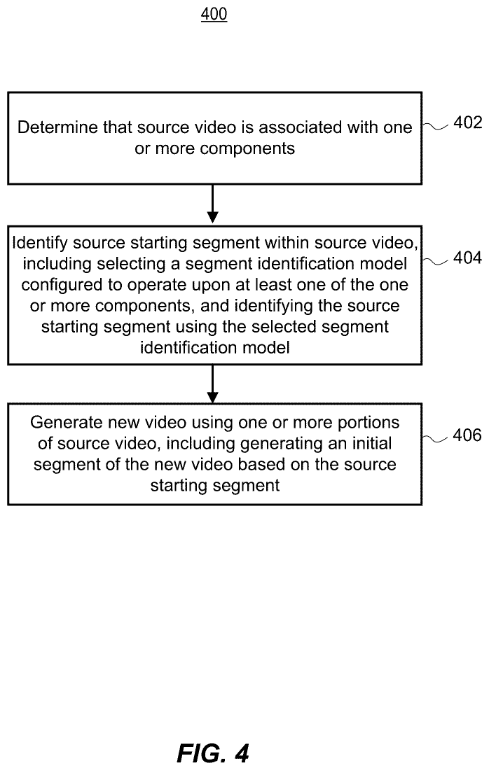

Referring first to the video transformation scheme 200 of FIG. 2A, the video transformer 130 shortens a source video 202 with N segments to a new video 204 with N−M+1 segments, where N and M are integers and N>M. The scheme 200 may be a particular implementation of the first aspect discussed above (and discussed below in connection with FIGS. 3A and 4), for example. In one implementation, for example, the video transformer 130 generates the new video 204 from the source video 202 by using model selector module 140 to identify one or more components of the source video 202 and select one or more of models 150, 152, 154 based on the identification (e.g., based on the presence or absence of a speech component). The video transformer 130 may then use mapping module 145 and the selected model(s) to identify the M-th segment of source video 202. The model(s) may select the M-th segment based on factors such as content relevance, visual quality, predicted emotional impact, and/or other factors. The video transformer 130 then generates the new video 204 such that new video 204 starts at the M-th segment and ends at the N-th segment of source video 202 (e.g., while maintaining the original sequence of the M-th through N-th segments as they exist in the source video 202). In other implementations and/or scenarios, the video transformer 130 generates the new video 204 so as to have a different ending segment than source video 202.

In the video transformation scheme 210 of FIG. 2B, the video transformer 130 uses one or more of models 150, 152, 154 to transform a source video 212 into a new video 214. FIG. 2B may correspond to the first and/or third aspects of the disclosure, for example. In the scheme 210, the video transformer 130 uses a technique that may be similar to that used in FIG. 2A, but provides an extra degree of flexibility by not requiring that segments M through N all be maintained/reused in the new video 214 (i.e., by allowing concatenation of segments that are non-contiguous in the source video 212). In this manner, the video transformer 130 can create a more seamless and cohesive viewing experience (e.g., by removing unnecessary information and/or distractions). In the particular example shown, the video transformer 130 determines to maintain/reuse one intervening segment, labeled as the “M+X” segment, but discards/ignores all segment(s) between the M-th and (M+X)-th segments, and discards/ignores all segment(s) between the (M+X)-th and N-th segments. In other examples, the video transformer reuses more than one intervening segment, or reuses no intervening segments. In each case, however, the relative time-ordering of segments from source video 212 is maintained in new video 214.

The video transformer 130 may use the same model that identified the M-th (starting) segment, or another model of models 150, 152, 154, to identify which intervening segments to reuse. Alternatively, the video transformer 130 may by default reuse the segments M-th through N-th segments, but use the same model that identified the M-th segment, or another model of models 150, 152, 154, to identify which intervening segments to discard/ignore. Generally, the model(s) may select segments based on factors such as content relevance, visual quality, predicted emotional impact, and/or other factors.

In the video transformation scheme 220 of FIG. 2C, the video transformer 130 uses one or more of models 150, 152, 154 to transform a source video 222 into a new video 224. FIG. 2C may correspond to the first and/or third aspects of the disclosure, for example. In the scheme 220, the video transformer 130 uses a technique that may be similar to that used in FIG. 2A or 2B, but provides still another degree of flexibility by not requiring that segments retain the relative time-ordering from the source video 222. In this manner, the video transformer 130 can create a more coherent and engaging narrative, and thus a more impactful and engaging video. In the particular example shown, the video transformer 130 determines to maintain/reuse one intervening segment, labeled as the “M+X” segment, discards/ignores all segment(s) between the M-th and (M+X)-th segments and all segment(s) between the (M+X)-th and N-th segments, and further determines to change the time order by positioning the (M+X)-th segment before the M-th segment in the new video 224. The video transformer 130 may use the same model that identified the M-th (starting) segment, or another model of models 150, 152, 154, to identify which intervening segments to reuse, and may use the same model or another model of models 150, 152, 154 to determine to reorder the selected/reused segments from the source video 222. Generally, the model(s) may reorder segments based on factors such as content relevance, visual quality, predicted emotional impact, storyline integrity, and/or other factors.

In the video transformation scheme 230 of FIG. 2D, the video transformer 130 uses one or more of models 150, 152, 154 to transform a source video 232 into a new video 234. FIG. 2D may correspond to the first and/or third aspects of the disclosure, for example. As noted above, in FIG. 2D, the larger boxes represent video frame segments while the smaller boxes represent corresponding audio segments. In the scheme 230, the video transformer 130 uses a technique that may be similar to that used in FIG. 2A, 2B, or 2C, but provides still another degree of flexibility by not requiring that segments retain the same audio-video correlation that existed in source video 232. In this manner, the video transformer 130 can provide a new perspective to existing content. In the particular example shown, the video transformer 130 determines to maintain/reuse one intervening segment, labeled as the “M+X” segment, discards/ignores all segment(s) between the M-th and (M+X)-th segments and all segment(s) between the (M+X)-th and N-th segments, determines to change the time order by positioning the (M+X)-th segment before the M-th segment in the new video 234, and further determines to modify which audio segments correspond to which video frame segments. In this example, the video transformer 130 reassigns the audio segment 1A (originally corresponding to video frame segment 1) to video frame segment M+X, reassigns the audio segment 2A (originally corresponding to video frame segment 2) to video frame segment M, and discards/ignores the original audio segments for video frame segments M+X and M.

The video transformer 130 may use the same model that identified the M-th (starting) segment, or different models of models 150, 152, 154, for each of (1) identifying which intervening video frame segments to reuse; (2) determining to reorder the selected/reused video frame segments from the source video 232; and (3) determining which audio segments to assign to which video frame segments. Generally, the model(s) may reassign audio segments based on factors such as content relevance, visual quality, predicted emotional impact, and/or degree of similarity between the audio and the video with respect to one or more metrics indicative of how dynamic the audio/video is, and/or other factors.

In the video transformation scheme 240 of FIG. 2E, the video transformer 130 uses one or more of models 150, 152, 154 to transform a source video 242 into a new video 244. FIG. 2E may correspond to the first, second, and/or third aspects of the disclosure, for example. As noted above, in FIG. 2E, the larger boxes represent video frame segments while the smaller boxes represent corresponding audio segments. In the scheme 240, the video transformer 130 uses a technique that may be similar to that used in FIG. 2A, 2B, 2C, or 2D, but provides still more flexibility by not requiring that corresponding audio segments from source video 242 be perfectly replicated, or perhaps reused at all, in new video 244. In this manner, the video transformer 130 can create a video that is more attractive to viewers (e.g., by creating a new, more exciting voice-over to accompany a beginning segment of new video 244), and/or that provides a new perspective on existing content. In the particular example shown, the video transformer 130: (1) determines to maintain/reuse one intervening segment, labeled as the “M+X” segment; (2) discards/ignores all segment(s) between the M-th and (M+X)-th segments and all segment(s) between the (M+X)-th and N-th segments; (3) determines to change the time order by positioning the (M+X)-th segment before the M-th segment in the new video 244; (4) determines to modify which audio segments correspond to which video frame segments; and (5) modifies audio segment 1A to become (or replaces audio segment 1A with) new audio segment 1A*.

The video transformer 130 may use the same model that identified the M-th (starting) segment, or different models of models 150, 152, 154, for each of: (1) identifying which intervening video frame segments to reuse; (2) determining to reorder the selected/reused video frame segments from the source video 242; (3) determining which audio segments to assign to which video frame segments; (4) determining which audio segments to modify or replace; and (5) generating new audio (e.g., modifying existing audio) accordingly. Generally, the model(s) may determine which audio segments to modify or replace, and/or generate the new audio or modify the existing audio, based on factors such as content relevance, visual quality, predicted emotional impact, storyline integrity, degree of similarity between the audio and the video with respect to one or more metrics indicative of how dynamic the audio/video is, and/or other factors.

In the video transformation scheme 250 of FIG. 2F, the video transformer 130 uses one or more of models 150, 152, 154 to transform a source video 252 into a new video 254. FIG. 2F may correspond to the first and/or third aspects of the disclosure, for example. In the scheme 250, the video transformer 130 uses a technique that may be similar to that used in FIG. 2A, 2B, 2C, 2D, or 2E, but provides still more flexibility by not requiring that video frame segments from source video 252 be perfectly replicated in new video 254. In this manner, the video transformer 130 can create a video that is more attractive or engaging to viewers. In the particular example shown, the video transformer 130: (1) determines to maintain/reuse one intervening segment, labeled as the “M+X” segment; (2) discards/ignores all segment(s) between the M-th and (M+X)-th segments and all segment(s) between the (M+X)-th and N-th segments; (3) determines to change the time order by positioning the (M+X)-th segment before the M-th segment in the new video 254; and (4) modifies the video frames of segment M+X to become new segment (M+X)*.

The video transformer 130 may use the same model that identified the M-th (starting) segment, or different models of models 150, 152, 154, for each of: (1) identifying which intervening video frame segments to reuse; (2) determining to reorder the selected/reused video frame segments from the source video 222; and (3) modifying video frames of a given segment of source video 252. Generally, the model(s) may modify existing video frame segments based on factors such as content relevance, visual quality, predicted emotional impact, storyline integrity, and/or other factors, while maintaining a degree of consistency with the overall storyline, etc., of the source video 252 (e.g., as summarized by scripting module 144).

While FIGS. 2A through 2F are generally shown and described as providing incrementally increasing layers of flexibility, it is to be understood that, in some implementations, the video transformer 130 may provide certain functionality associated with later figures (e.g., modifying video frame segments) without providing certain functionality of earlier figures (e.g., reassigning audio segments to new video frame segments).

Returning now to the first aspect of the present disclosure, FIG. 3A depicts an example process 300 for transforming a source video 302 into a new video 316 according to the first aspect. The process 300 may be implemented by the computing system 102 of FIG. 1 (e.g., by video transformer 130), for example.

In the process 300, at stage 304, the S2T/T2S module 146 generates a speech transcript from the audio component of the source video 302. In other implementations, a speech transcript is already available, and stage 304 is omitted.

At stage 306, the model selector module 140 determines/detects the presence of one or more components of source video 302. For example, the model selector module 140 may determine that source video 302 is, or is not, associated with an audio component. As another example, the model selector module 140 may more specifically determine that source video 302 is, or is not, associated with a speech component. In some of these latter implementations, the model selector module 140 determines whether source video 302 is associated with a speech component based on whether the S2T/T2S module 146 was successful in attempting to generate a speech transcript. The S2T/T2S module 146 may fail to generate a speech transcript due to the absence of any speech, or the absence of any sufficiently coherent speech, in the audio, for example.

At stage 308, the model selector module 140 selects at least one of models 150, 152, 154, based at least in part on the outcome of stage 306. For example, the model selector module 140 may select an LLM of models 150, 152, 154 in response to the S2T/T2S module 146 successfully outputting a speech transcript, and otherwise not select the LLM. In some implementations and/or scenarios, the model selector module 140 at stage 308 selects two or more of models 150, 152, 154. For example, in the earlier example where model 150 is an LLM, model 152 is a combination of a rules-based model and a neural network that processes at least video frames in a predetermined time window near the end of the source video, and model 154 is another neural network that processes video and audio, the model selector module 140 at stage 308: (1) select the model 150 and the model 154, but not the model 152, when the S2T/T2S module 146 successfully outputs a speech transcript; and (2) select the model 152 and the model 154 when the S2T/T2S module 146 fails to output a speech transcript.

In some implementations, stage 308 includes applying a hierarchical set of rules. For example, the model selector module 140 may at stage 308: (1) select only the model 150 when the S2T/T2S module 146 successfully outputs a speech transcript; and (2) if the S2T/T2S module 146 fails to output a speech transcript, select either model 152 or 154 based on one or more other characteristics of the source video (e.g., length, resolution, etc.).

At stage 310, the mapping module 145 uses the selected model(s) to identify a starting segment of the source video 302 (i.e., to identify a segment of source video 302 to be used as a starting segment for new video 316). If a selected model is an LLM that processes a speech transcript, for example, the LLM may output an indication of a first word of speech within the segment. As another example, if the selected model is a neural network that processes video frames and/or accompanying raw audio, the neural network may output a time stamp, a segment identifier, or any other suitable indicator of a particular segment.

At stage 312, the video transformer 130 may perform one or more post-processing operations. In some implementations, at stage 312, the mapping module 145 or another module precisely adjusts a starting point, using the beginning of the segment selected at stage 310 as a starting point. For example, the mapping module 145 or other module may shift the start of the source starting segment to a point corresponding to a boundary between adjacent words. Additionally or alternatively, the mapping module 145 or other module may shift the start of the source starting segment to a point corresponding to a boundary between adjacent scenes (e.g., with said boundary being detected using a neural network or other machine learning model and/or rules).

At stage 314, the video transformer 130 assembles or otherwise generates the new video 316 using the starting segment selected/identified at stage 310 (as adjusted by any post-processing at stage 312). In some implementations, stage 314 includes exactly replicating a portion of the source video 302 that begins at the identified starting point and ends at the end of source video 302. In other implementations, stage 314 includes using the identified starting point/segment as a beginning of the new video 316, but also uses the techniques/schemes of any one or more of FIGS. 2B through 2F to generate the new video 316.

FIG. 3B depicts an example process 320 for transforming a source video 322 into a new video 336 according to the third aspect of the present disclosure, which may be implemented by the computing system 102 of FIG. 1 (e.g., by video transformer 130), for example. For ease of reference, the description below of process 320 refers to a “generative AI engine,” which, as noted above, may be a single generative AI model (e.g., LLM) or a collection of multiple generative AI models, and which may or may not also include one or more other types of AI/ML models. For example, the generative AI engine may include models 150, 152, and/or 154, some or all of which may be LLMs (e.g., with different hyperparameters, training, and/or fine-tuning). As another example, the generative AI engine may include only model 150 (e.g., a single LLM).

In the process 320, at stage 324, the segmenting module 142 segments the source video 322 into a plurality of source video segments. For example, segmenting module 142 may prompt a multimodal LLM of the generative AI engine to segment the source video 322 into scenes, shots, or other suitable divisions. In other implementations, segmenting module 142 may use a different type of model to segment the source video 322, or may apply rules to segment the source video 322 into units such as fixed-duration segments, etc. In some implementations, the segments of the source video 322 can be of different (e.g., arbitrary) durations.

At stage 326, the scripting module 144 generates a script for the new video 336. The script may include a respective descriptor for each of one or more segments (e.g., different scenes) of the new video 336. As used herein, a “segment” of a new video may refer to the entirety of the new video, i.e., in implementations and/or scenarios where the new video includes only a single segment. The scripting module 144 may use an LLM of the generative AI engine to generate the script at stage 326. The LLM may determine the number of segments (e.g., number of scenes) for the new video 336, or a prompt to the LLM may specify the number of segments, for example.

Each descriptor of the script may provide details such as setting, actions, storyline, feel, etc., and may be phrased in any suitable manner, such as an instruction for a later prompt that will be used to generate the new video 336. As just one example, a descriptor for an opening scene of new video 336 may be: “Start with a catchy introduction that sets the scene and introduces the product, emphasizing its unique selling point.”

The prompt to the LLM may also instruct the LLM to include in the script a respective voice-over transcript segment for each of the one or more segments of new video 336. In some implementations, the transcript segments need not align precisely with any action occurring in the new video 336 (e.g., need not include words being spoken by characters portrayed in the new video 336), in order to simplify the process.

The prompt to the LLM may also instruct the LLM to include in the script a respective duration for each of the one or more segments of the new video 336. The duration may be an estimated time of the corresponding segment, as the true time may not be known until after stage 328 (discussed below). In some implementations, the prompt to the LLM at stage 326 may specify a user-specified parameter (or AI agent-specified parameter, etc.) that indicates the total desired duration for the new video 336. In such implementations, the prompt may instruct the LLM to constrain the sum of the segment duration estimates such that the sum is equal the total desired duration (or such that the sum is within a threshold amount or percentage of the total desired duration, etc.).

In some implementations, script generation at stage 326 is based on the source video 322. For example, scripting module 144 may use a multimodal LLM of the generative AI engine at stage 326, and input to the multimodal LLM both the source video 322 and a prompt indicating requested/desired new video characteristics such as total duration (e.g., “10 seconds” or “shorter than the source video,” etc.), desired qualities (e.g., “meeting the highest advertising standards,” “concise and compelling,” etc.), and so on.

At stage 328, the S2T/T2S module 146 generates the voice audio component using a suitable T2S technique. In some implementations, the type of voice (e.g., gender, vocal qualities, etc.) is specified by the script generated at stage 326 (e.g., in the descriptor for a segment, or as a separate, additional information element, etc.).

At stage 330, mapping module 145 selects a respective set of one or more segments of source video 322 (as delineated at stage 324) for inclusion in each of some or all of the segment(s) of the new video 336. For example, the script generated at stage 326 may include a particular number of descriptors and corresponding voice-over transcript segments (and possibly estimated durations), with that number being the number of scenes, and at stage 330 the mapping module 145 may select one or more of the source video segments from stage 324 for inclusion in each of those scenes. Generally, the mapping module 145 attempts to select source video segments that are most suitable for each new video segment, while also constraining the selection such that the total duration of the selected source video segments is less than (or within a threshold amount or percentage of, etc.) the corresponding new video segment. In some implementations, mapping module 145 achieves this by inputting some or all of the source video segments, along with some or all of the new video segment descriptors generated at stage 326, to a multimodal LLM of the generative AI engine (e.g., a same LLM used at stage 326, or a different LLM). The prompt to the multimodal LLM may also include instructions to select the source video segments for each new video segment according to one or more criteria (e.g., in a manner that is most impactful, such that the source video segment(s) are most similar to the descriptor, such that the time constraints are met as noted above, etc.).

In an alternative implementation, the mapping module 145 uses stored embeddings at stage 330. For example, stage 324 may include generating an embedding for each source video segment (e.g., a direct embedding of the segment, or using an LLM to generate a text descriptor for the segment and then generating an embedding for the text descriptor, etc.), stage 326 may include generating an embedding for each new video segment descriptor, and stage 330 may include using cosine similarity or another suitable metric/technique to determine which source video segment(s) to include in each new video segment.

As indicated by the dashed line in FIG. 3B, in some implementations, the mapping module 145 can use the actual durations of the voice-over for each segment (as generated at stage 328), rather than duration estimates in the script (i.e., from stage 326), to align the total duration of the selected source video segment(s) with the duration of a particular new video segment. This can advantageously provide more reliable time alignment (e.g., be less likely to need iterative corrections as discussed below in connection with FIG. 3C), for example.

At stage 332, video transformer 130 performs one or more post-processing operations on the selected source video segments from stage 330. While shown before stage 334 in the flow of FIG. 3B, the post-processing operation(s) of stage 332 may occur before and/or after assembly at stage 334 (discussed further below). Stage 332 may include, for example, clipping terminal parts of selected source video segments (e.g., the terminal part of the last source video segment for a particular new video segment) in order to better match the durations of the corresponding new video segments, adding video to selected source video segments (e.g., using the generative AI engine) in order to better match the durations of the corresponding new video segments, and so on. Generally, it is to be understood that selecting a source video segment (at stage 330) for “inclusion” or “insertion” in the new video 336 does not necessarily mean (but may mean) that the source video segment is included in the new video 336 without any modification.

At stage 334, the video transformer 130 assembles or otherwise generates the new video 336 using the selected (and possibly post-processed) source video segments and in accordance with the sequential order of their corresponding new video segments. For example, if source video segments 3 and 5 were selected at stage 330 for the first/initial scene of new video 336, and source video segment 2 was selected at stage 330 for the second/next scene of new video 336, the new video 336 may be assembled/generated at stage 334 such that the new video starts with source video segments 3, 5, and 2, in that order.

FIG. 3C depicts an example language model-based architecture 360 for implementing the process 320 of FIG. 3B with iterative tuning, according to one implementation. In the example architecture 360, segmenting prompt 362 may be a prompt to a multimodal LLM used at stage 324, scripting prompt 364 may be a prompt to a multimodal LLM (the same as or different from the LLM to which prompt 362 is applied) used at stage 326, and segment selection prompt 366 may be a prompt to a multimodal LLM (the same as or different from the LLM(s) to which prompts 362 and/or 364 are applied) used at stage 330. For clarity, FIG. 3C does not show the models (e.g., LLMs). It is understood that arrows from a first prompt to a second prompt in FIG. 3C represent, in some implementations, the first prompt being input to a language model, with an output of the language model then being used to generate at least a part of the second prompt.

At stage 370, the video transformer 130 performs one or more verification checks on the new video 336 (possibly after stages 332 and/or 334, not shown in FIG. 3C). For example, stage 370 may include checking whether the total duration of new video 336 is within a threshold (e.g., threshold number of seconds, threshold percentage, etc.) of a desired duration specified in the scripting prompt 364. Additionally or alternatively, stage 370 may include checking whether one or more other criteria are satisfied (e.g., brand guideline and/or ethical criteria being met, a quality score generated by an AI agent satisfying a threshold, a predicted advertisement performance satisfying a threshold, etc.).

If the check(s) indicate the new video 336 is acceptable, the new video 336 may be released for use (e.g., in an advertising campaign), or provided to an entity (e.g., advertiser) for approval, etc. If the check(s) indicate the new video 336 is not acceptable, however, the reason(s) for non-conformance may be input as part of an adjustment prompt 372 to a language model (e.g., LLM) of the generative AI engine, which may then output instructions for correcting the issue(s). The output instructions may be inserted into the scripting prompt 364 for another iteration. As one example, if stage 370 indicates that the total duration of new video 336 exceeds the desired duration by more than a threshold amount of time (e.g., by more than one second), the overage time may be included in adjustment prompt 372 and applied to an LLM. The LLM may then output instructions that at least one scene be shortened such that the total new video duration is shorter by the overage time. The iterative process may continue until the total duration is within the threshold amount of time.

FIG. 4 is a flow diagram of an example method 400 for transforming a source video into a new video according to the first aspect of the present disclosure. The method 400 may be implemented by the computing system 102 (e.g., video transformer 130, as executed by processor 122) of FIG. 1, for example.

At block 402, the method 400 includes determining that the source video is associated with one or more components (e.g., an audio component, or specifically a speech component, etc.).

At block 404, the method 400 includes identifying a source starting segment within the source video. Block 404 may include selecting a segment identification model (e.g., one of models 150, 152, 154) that is configured to operate upon at least one of the one or more components identified at block 402, and identifying the source starting segment using the selected identification model. In some implementations, block 404 includes identifying a plurality of candidate source starting segments using a plurality of respective selected identification models, and then identifying a particular starting segment from the candidates based on one or more factors (e.g., based on performance indicators or metrics predicted by a machine learning model).

At block 406, the method 400 includes generating the new video using one or more portions of the source video, at least in part by generating an initial segment of the new video based on the source starting segment identified at block 404. For example, block 406 may include using the identified source starting segment as the first (or only) segment of the new video, or may include using a generative AI model to modify the identified source starting segment before using the segment as the first segment of the new video, etc.

In other implementations, the method 400 may include more or fewer blocks, and/or certain blocks may occur in an order other than what is shown in FIG. 4.

In some implementations, selecting the segment identification model at block 404 includes selecting a first machine learning model (e.g., model 150), and identifying the source starting segment at block 404 includes applying a predetermined portion of the source video to the first machine learning model, the predetermined portion being entirely within a time window that is between a last 20 seconds of the source video and a last 5 seconds of the source video (e.g., extending from the last 15 seconds to the last 10 seconds of the source video).

In some implementations, generating the new video at block 406 includes causing the initial segment of the new video to begin at the source starting segment and continue (i.e., according to the original sequence of the source video) until an end of the source video with a same sequence as the source video. Additionally or alternatively, generating the new video at block 406 may include shifting a start of the source starting segment to a point corresponding to a boundary between adjacent words, and causing the initial segment of the new video to begin at the shifted start of the source video. Additionally or alternatively, generating the new video at block 406 may include shifting a start of the source starting segment to a point corresponding to a boundary between adjacent scenes, and causing the initial segment of the new video to begin at the shifted start of the source video. In each of these contexts, “causing” a certain arrangement of the new video can include directly generating the new video accordingly, and/or automatically accessing/using other software tools (e.g., via an application programming interface) to arrange the new video in such a manner, for example.

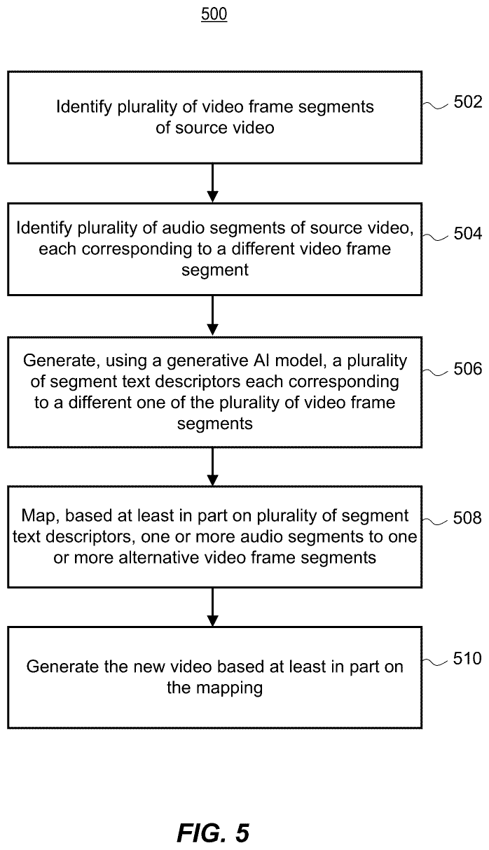

FIG. 5 is a flow diagram of an example method 500 for transforming a source video into a new video according to a second aspect of the present disclosure. The method 500 may be implemented by the computing system 102 (e.g., video transformer 130, as executed by processor 122) of FIG. 1, for example. The scheme 230 of FIG. 2D is one example implementation and scenario of the second aspect.

At block 502, video frame segments of the source video are identified. Block 502 may include dividing/segmenting the source video (e.g., by segmenting module 142) or analyzing metadata (e.g., time stamps) associated with the source video, for example. In some implementations, block 502 includes using the generative AI model or a different AI model to identify boundaries between the video frame segments.

At block 504, audio segments of the source video are identified, with each audio segment corresponding to a different video frame segment. Block 504 may include simply identifying the audio segments that are time-aligned with the identified video frame segments, or may include dividing/segmenting an analog component of the source video (e.g., by segmenting module 142), for example. In some implementations, block 504 includes using time stamps associated with the video frame segments to identify the audio segments.

At block 506, segment text descriptors are generated (e.g., by scripting module 144) using a generative AI model (e.g., a multimodal LLM). Each of the segment text descriptors corresponds to a different one of the video frame segments. For example, block 506 may include inputting each video frame segment, and a respective prompt, into a multimodal LLM, with the output being the respective segment text descriptor for that video frame segment.

At block 508, one or more of the identified audio segments is/are mapped (e.g., by mapping module 145) to one or more alternative video frame segments (i.e., other than the corresponding video frame segments in the source video), based at least in part on the segment text descriptors generated at block 506. In some implementations, block 508 includes generating a transcript of the plurality of audio segments and mapping portions of the transcript that correspond to the one or more audio segments to particular ones of the segment text descriptors that correspond to the one or more alternative video frame segments. In some implementations, block 508 includes using the generative AI model, or a different AI model, to determine similarity (e.g., a cosine similarity or other similarity metric calculated based on text embeddings) between the portions of the transcript and the particular segment text descriptors.

At block 510, the new video is generated based at least in part on the mapping of block 508. In the new video, the method 500 aligns the audio segments that were re-mapped at block 508 with the alternative video frame segments (or, in some implementations, with video frame segments derived from the alternative video frame segments using techniques such as generative AI).

In other implementations, the method 500 may include more or fewer blocks, and/or certain blocks may occur in an order other than what is shown in FIG. 5. In some implementations, for example, the method 500 also includes identifying a source starting segment within the source video, and block 510 includes using the source starting segment as an initial segment of the new video.

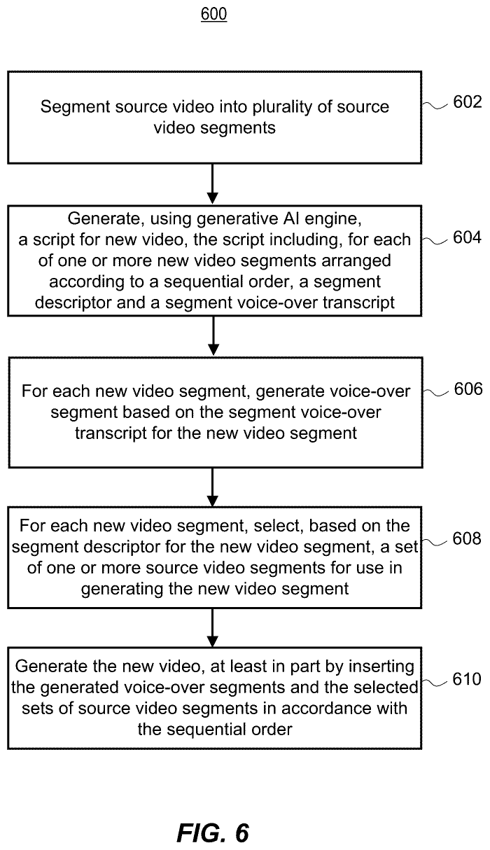

FIG. 6 is a flow diagram of an example method 600 for transforming a source video into a new video, according to a third aspect of the present disclosure. The method 600 may be implemented by the computing system 102 (e.g., video transformer 130, as executed by processor 122) of FIG. 1, for example. The scheme 240 of FIG. 2E is one example implementation and scenario of the third aspect.

At block 602, the source video is segmented into a plurality of source video segments. Block 602 may include dividing/segmenting the source video (e.g., by segmenting module 142) by processing frames of the source video and/or by analyzing metadata (e.g., time stamps) associated with the source video, for example. The video segments may be video frame segments, or segments of combined audio (e.g., background music) and video, depending on the implementation and/or scenario. In some implementations, block 602 includes identifying the video segments by identifying boundaries between the video segments using a generative AI engine (e.g., model 150), such as boundaries between scenes, shots, etc.

At block 604, a script for the new video is generated using a generative AI engine (e.g., model 150 or 152). The script includes, for each of one or more new video segments arranged according to a sequential order, a segment descriptor and a segment voice-over transcript. For example, block 604 may include inputting the source video and a prompt into a multimodal LLM, with the output being the segment descriptors and corresponding segment voice-over transcripts. The script may also include an estimated duration for each segment. The prompt may be designed so as to achieve one or more goals (e.g., “Total duration=10 seconds”, “Summarize the [source] video in a manner that would quickly grab a reader's attention”, and/or “Summarize the [source] video in a manner that focuses on why a reader should buy the product advertised by the [source] video”), for example. In some implementations, the prompt includes instructions to identify certain features of the source video to help generate the new video. For example, the prompt may include instructions to identify a storyline of the source video, a product or service featured in the source video, and/or a call to action in the source video.

At block 606, a voice-over segment is generated for each new video segment (e.g., using S2T/T2S module 146), based on the voice-over transcript for the new video segment. It is understood that the voice-over transcript (and thus, the voice-over itself) for a given new video segment may be empty/blank (i.e., the script may be generated such that some segments of the new video may have no voice-over).

At block 608, for each new video segment, a set of one or more source video segments, for use in the new video segment, is selected based on the segment descriptor for the new video segment. In some implementations, the set of source video segment(s) is also selected based on other information, such as an estimated duration of the corresponding new video segment (e.g., as specified in the generated script). Block 608 may include a multimodal LLM processing the source video segments, new video segment descriptors, and possibly new video segment estimated durations to select the set of source video segment(s). A prompt to the LLM may instruct the LLM to select source video segment(s) based on one or more criteria (e.g., as discussed above in connection with mapping module 145).

At block 610, the new video is generated, at least in part by inserting the generated voice-over segments and the selected sets of source video segments in accordance with the sequential order. In some implementations, post-processing may be used at block 610 to align new video segments with their corresponding voice-over durations (e.g., by clipping, adding content, etc.), to modify or review the inserted segments, and/or for other purposes.

In other implementations, the method 600 may include more or fewer blocks, and/or certain blocks may occur in an order other than what is shown in FIG. 6. In some implementations, for example, the method 600 includes a first additional block in which the new video is checked according to one or more criteria (e.g., whether new video segments adequately match the duration of their corresponding voice-overs), a second additional block in which a prompt is generated based on the reason(s) the one or more criteria were not satisfied, and a third additional block in which the prompt is input to an LLM that modifies the prompt for script-generation (e.g., at another iteration of block 604).

As is apparent from the above description, some of the techniques disclosed herein use artificial intelligence to generate high-performing videos. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and finetuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

In some implementations, the computing system 102 may use one or more of the machine learning models or techniques noted above to perform any one or more of the operations discussed herein in connection with machine learning. For example, the computing system 102 may use one or more such machine learning techniques to segment a video, to generate a text descriptor for a video or video segment, to generate a script (e.g., scene descriptors and scene voice-over transcripts) based on a source video, to re-map audio segments to alternative video segments, to modify video segments, to identify a segment in a source video for use as a starting segment in a new video, to predict performance of a video, and so on.

Although the foregoing text sets forth a detailed description of numerous different aspects and implementations of the invention, it should be understood that the scope of the patent is defined by the words of the claims set forth at the end of this patent. The detailed description is to be construed as exemplary only and does not describe every possible implementation because describing every possible implementation would be impractical, if not impossible. Numerous alternative implementations could be implemented, using either current technology or technology developed after the filing date of this patent, which would still fall within the scope of the claims. The disclosure herein contemplates at least the following examples:

Example 1. A method for generating a new video from a source video, the method comprising: determining, by one or more processors, that the source video is associated with one or more components; identifying, by the one or more processors, a source starting segment within the source video, at least in part by: selecting a segment identification model, from among a plurality of candidate segment identification models, based at least in part on the segment identification model being configured to operate upon at least one of the one or more components; and identifying the source starting segment by using the selected segment identification model to process at least a portion of the source video; and generating, by the one or more processors, the new video using one or more portions of the source video, wherein generating the new video includes generating an initial segment of the new video based on the source starting segment.

Example 2. The method of example 1, wherein: determining that the source video is associated with the one or more components includes determining that the source video is associated with a speech component; selecting the segment identification model includes selecting a first machine learning model, the first machine learning model including a large language model; and identifying the source starting segment includes applying a prompt, and a transcript of at least a portion of the speech component, to the first machine learning model.

Example 3. The method of example 2, wherein identifying the source starting segment includes outputting, by the first machine learning model, an indication of text corresponding to the source starting segment.

Example 4. The method of example 1, wherein: selecting the segment identification model includes selecting a first machine learning model; and identifying the source starting segment includes applying at least a portion of audio, and video frames, of the source video to the first machine learning model.

Example 5. The method of example 4, wherein identifying the source starting segment includes outputting, by the first machine learning model, an indication of a source starting audio segment or a source starting video segment.

Example 6. The method of example 1, wherein: selecting the segment identification model includes selecting a first machine learning model; and identifying the source starting segment includes applying a predetermined portion of the source video to the first machine learning model, the predetermined portion being entirely within a time window that is between a last 20 seconds of the source video and a last 5 seconds of the source video. Example 7. The method of example 1, wherein generating the new video includes causing the initial segment of the new video to begin at the source starting segment and continue until an end of the source video with a same sequence as the source video.

Example 8. The method of example 1, wherein generating the new video includes: shifting a start of the source starting segment to a point corresponding to a boundary between adjacent words; and causing the initial segment of the new video to begin at the shifted start of the source video.

Example 9. The method of example 1, wherein generating the new video includes: shifting a start of the source starting segment to a point corresponding to a boundary between adjacent scenes; and causing the initial segment of the new video to begin at the shifted start of the source video.

Example 10. The method of example 1, wherein the plurality of candidate segment identification models includes a plurality of machine learning models, and wherein identifying the source starting segment within the source video includes: for each machine learning model of the plurality of machine learning models, identifying a respective candidate starting segment by applying at least a portion of (i) the source video, or (ii) a transcript of a speech component of the source video, to the machine learning model, and predicting, using an additional machine learning model, a respective performance metric associated with the respective candidate starting segment; and identifying the source starting segment based on the respective performance metrics for the plurality of machine learning models.

Example 11. A system comprising: one or more processors; and one or more memories storing instructions that, when executed by the one or more processors, cause the one or more processors to perform operations comprising: determining that a source video is associated with one or more components; identifying a source starting segment within the source video, at least in part by (i) selecting a segment identification model, from among a plurality of candidate segment identification models, based at least in part on the segment identification model being configured to operate upon at least one of the one or more components, and (ii) identifying the source starting segment by using the selected segment identification model to process at least a portion of the source video; and generating a new video using one or more portions of the source video, wherein generating the new video includes generating an initial segment of the new video based on the source starting segment.

Example 12. The system of example 11, wherein identifying the source starting segment includes: determining that the source video is associated with the one or more components includes determining that the source video is associated with a speech component; selecting the segment identification model includes selecting a first machine learning model, the first machine learning model including a large language model; and identifying the source starting segment includes applying a prompt, and a transcript of at least a portion of the speech component, to the first machine learning model.

Example 13. The system of example 12, wherein identifying the source starting segment includes outputting, by the first machine learning model, an indication of text corresponding to the source starting segment.

Example 14. The system of example 11, wherein: selecting the segment identification model includes selecting a first machine learning model; and identifying the source starting segment includes applying at least a portion of audio and video frames of the source video to the first machine learning model.

Example 15. The system of example 14, wherein identifying the source starting segment includes outputting, by the first machine learning model, an indication of a source starting audio segment or a source starting video segment.

Example 16. The system of example 11, wherein: selecting the segment identification model includes selecting a first machine learning model; and identifying the source starting segment includes applying a predetermined portion of the source video to the first machine learning model, the predetermined portion being entirely within a time window that is between a last 20 seconds of the source video and a last 5 seconds of the source video.

Example 17. The system of example 11, wherein generating the new video includes causing the initial segment of the new video to begin at the source starting segment and continue until an end of the source video with a same sequence as the source video.

Example 18. The system of example 11, wherein generating the new video includes: shifting a start of the source starting segment to a point corresponding to a boundary between adjacent words; and causing the initial segment of the new video to begin at the shifted start of the source video.

Example 19. The system of example 11, wherein generating the new video includes: shifting a start of the source starting segment to a point corresponding to a boundary between adjacent scenes; and causing the initial segment of the new video to begin at the shifted start of the source video.

Example 20. The system of example 11, wherein the plurality of candidate segment identification models includes a plurality of machine learning models, and wherein identifying the source starting segment within the source video includes: for each machine learning model of the plurality of machine learning models, identifying a respective candidate starting segment by applying at least a portion of (i) the source video, or (ii) a transcript of a speech component of the source video, to the machine learning model, and predicting, using an additional machine learning model, a respective performance metric associated with the respective candidate starting segment; and identifying the source starting segment based on the respective performance metrics for the plurality of machine learning models.

Example 21. A method for generating a new video from a source video, the method comprising: identifying, by one or more processors, a plurality of video frame segments of the source video; identifying, by the one or more processors, a plurality of audio segments of the source video, wherein each of the plurality of audio segments corresponds to a different one of the plurality of video frame segments; generating, by the one or more processors and using a generative artificial intelligence model, a plurality of segment text descriptors each corresponding to a different one of the plurality of video frame segments; mapping, by the one or more processors and based at least in part on the plurality of segment text descriptors, one or more audio segments of the plurality of audio segments to one or more alternative video frame segments of the plurality of video frame segments; and generating, by the one or more processors and based at least in part on the mapping of the one or more audio segments to the one or more alternative video frame segments, the new video.

Example 22. The method of example 21, further comprising: identifying, by the one or more processors, a source starting segment within the source video, wherein generating the new video includes using the source starting segment as an initial segment of the new video.

Example 23. The method of example 21, wherein mapping the one or more audio segments to the one or more alternative video frame segments includes: generating a transcript of the plurality of audio segments; and mapping portions of the transcript that correspond to the one or more audio segments to particular segment text descriptors, of the plurality of segment text descriptors, that correspond to the one or more alternative video frame segments.

Example 24. The method of example 23, wherein mapping the portions of the transcript to the particular segment text descriptors includes using the generative artificial intelligence model or a different artificial intelligence model to determine similarity between the portions of the transcript and the particular segment text descriptors.

Example 25. The method of any one of examples 21-24, wherein identifying the plurality of video frame segments includes using the generative artificial intelligence model or a different artificial intelligence model to identify boundaries between the plurality of video frame segments.

Example 26. The method of any one of examples 21-25, wherein identifying the plurality of audio segments includes identifying the plurality of audio segments using time stamps associated with the plurality of video frame segments.

Example 27. A system comprising: one or more processors; and one or more memories storing instructions that, when executed by the one or more processors, cause the one or more processors to perform the method of any one of examples 21-26.

Example 28. A method for generating a new video from a source video, the method comprising: segmenting, by one or more processors, the source video into a plurality of source video segments; generating, by the one or more processors and using a generative artificial intelligence (AI) engine comprising one or more generative AI models, a script for the new video, the script including, for each of one or more new video segments arranged according to a sequential order, a segment descriptor and a segment voice-over transcript; for each new video segment of the one or more new video segments, generating, by the one or more processors and based on the segment voice-over transcript for the new video segment, a voice-over segment, and selecting, by the one or more processors, based on the segment descriptor for the new video segment, and from among the plurality of source video segments, a set of one or more source video segments for use in generating the new video segment; and generating, by the one or more processors, the new video, at least in part by inserting the generated voice-over segments for the one or more new video segments, and the selected sets of one or more source video segments for the one or more new video segments, in accordance with the sequential order.

Example 29. The method of example 28, wherein generating the script for the new video includes generating the script by inputting the source video to the generative AI engine.

Example 30. The method of examples 29, wherein generating the script for the new video includes generating the script by inputting the source video and one or more user criteria to the generative AI engine, the one or more user criteria corresponding to requested characteristics of the new video.

Example 31. The method of examples 30, wherein: the one or more user criteria include a requested duration of the new video; the script further includes, for each of the one or more new video segments, an estimated segment duration; and generating the script includes determining the estimated segment durations for the one or more new video segments based on the requested duration.

Example 32. The method of any one of examples 28-31, wherein selecting the set of one or more source video segments for use in generating the new video segment includes inputting (i) at least a portion of the plurality of source video segments, (ii) the segment descriptor for the new video segment, and (iii) a prompt, to the generative AI engine.

Example 33. The method of examples 32, wherein: the script further includes, for each of the one or more new video segments, an estimated segment duration; and selecting the set of one or more source video segments for use in generating the new video segment includes inputting (i) at least some of the plurality of source video segments, (ii) the segment descriptor for the new video segment, (iii) the prompt, and (iv) the estimated segment duration, to the generative AI engine.

Example 34. The method of any one of examples 28-31, wherein selecting the set of one or more source video segments for use in generating the new video segment includes: generating embeddings for at least some of the plurality of segments; generating an embedding for the segment descriptor for the new video segment; and selecting the set of one or more source video segments based on the embeddings for the at least some of the plurality of segments and the embedding for the segment descriptor.

Example 35. The method of any one of examples 28-34, wherein segmenting the source video into the plurality of source video segments includes segmenting the source video into different video scenes or different shots.

Example 36. The method of any one of examples 28-35, wherein: the one or more new video segments include a plurality of new video segments; and each video segment of the plurality of new video segments corresponds to a different video scene, or a different shot, of the new video.

Example 37. The method of any one of examples 28-36, wherein: segmenting the source video into the plurality of source video segments is performed by a first generative AI model of the generative AI engine; and generating the script for the new video is performed by a second generative AI model of the generative AI engine.

Example 38. The method of any one of examples 28-37, wherein selecting the set of one or more source video segments for use in generating the new video segment is performed by a third generative AI model of the generative AI engine.

Example 39. The method of any one of examples 28-38, wherein generating the new video includes, after inserting the generated voice-over segments for the one or more new video segments, and the selected sets of one or more source video segments for the one or more new video segments, in accordance with the sequential order: performing one or more post-processing operations to generate the new video.

Example 40. A system comprising: one or more processors; and one or more memories storing instructions that, when executed by the one or more processors, cause the one or more processors to perform the method of any one of examples 28-39.

Example 41. One or more non-transitory, computer-readable media storing instructions that, when executed by the one or more processors, cause the one or more processors to perform the method of any one of examples 28-39.

The following additional considerations apply to the foregoing discussion and the appended claims. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first set of one or more processors (e.g., in a first computing device) generates X and a distinct, second set of one or more processors (e.g., in a different, second computing device) independently generates Y; (2) implementations in which all processors in the set of one or more processors (e.g., all in the same device, or distributed among multiple devices) contribute to the generation of both X and Y; and (3) other variations.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

What is claimed is:

1. A method for generating a new video from a source video, the method comprising:
segmenting, by one or more processors, the source video into a plurality of source video segments;
generating, by the one or more processors and using a generative artificial intelligence (AI) engine comprising one or more generative AI models, a script for the new video, the script including, for each of one or more new video segments arranged according to a sequential order, a segment descriptor and a segment voice-over transcript;
for each new video segment of the one or more new video segments,
generating, by the one or more processors and based on the segment voice-over transcript for the new video segment, a voice-over segment, and
selecting, by the one or more processors, based on the segment descriptor for the new video segment, and from among the plurality of source video segments, a set of one or more source video segments for use in generating the new video segment; and
generating, by the one or more processors, the new video, at least in part by inserting the generated voice-over segments for the one or more new video segments, and the selected sets of one or more source video segments for the one or more new video segments, in accordance with the sequential order.

2. The method of claim 1, wherein generating the script for the new video includes generating the script by inputting the source video to the generative AI engine.

3. The method of claim 2, wherein generating the script for the new video includes generating the script by inputting the source video and one or more user criteria to the generative AI engine, the one or more user criteria corresponding to requested characteristics of the new video.

4. The method of claim 3, wherein:
the one or more user criteria include a requested duration of the new video;
the script further includes, for each of the one or more new video segments, an estimated segment duration; and
generating the script includes determining the estimated segment durations for the one or more new video segments based on the requested duration.

5. The method of claim 1, wherein selecting the set of one or more source video segments for use in generating the new video segment includes inputting (i) at least a portion of the plurality of source video segments, (ii) the segment descriptor for the new video segment, and (iii) a prompt, to the generative AI engine.

6. The method of claim 5, wherein:
the script further includes, for each of the one or more new video segments, an estimated segment duration; and
selecting the set of one or more source video segments for use in generating the new video segment includes inputting (i) at least some of the plurality of source video segments, (ii) the segment descriptor for the new video segment, (iii) the prompt, and (iv) the estimated segment duration, to the generative AI engine.

7. The method of claim 1, wherein selecting the set of one or more source video segments for use in generating the new video segment includes:
generating embeddings for at least some of the plurality of segments;
generating an embedding for the segment descriptor for the new video segment; and
selecting the set of one or more source video segments based on the embeddings for the at least some of the plurality of segments and the embedding for the segment descriptor.

8. The method of claim 1, wherein segmenting the source video into the plurality of source video segments includes segmenting the source video into different video scenes or different shots.

9. The method of claim 1, wherein:
the one or more new video segments include a plurality of new video segments; and
each video segment of the plurality of new video segments corresponds to a different video scene, or a different shot, of the new video.

10. The method of claim 1, wherein:
segmenting the source video into the plurality of source video segments is performed by a first generative AI model of the generative AI engine; and
generating the script for the new video is performed by a second generative AI model of the generative AI engine.

11. The method of claim 10, wherein selecting the set of one or more source video segments for use in generating the new video segment is performed by a third generative AI model of the generative AI engine.

12. The method of claim 1, wherein generating the new video includes, after inserting the generated voice-over segments for the one or more new video segments, and the selected sets of one or more source video segments for the one or more new video segments, in accordance with the sequential order:
performing one or more post-processing operations to generate the new video.

13. A system comprising:
one or more processors; and
one or more memories storing instructions that, when executed by the one or more processors, cause the one or more processors to perform operations comprising:
segmenting a source video into a plurality of source video segments;
generating, using a generative artificial intelligence (AI) engine comprising one or more generative AI models, a script for a new video, the script including, for each of one or more new video segments arranged according to a sequential order, a segment descriptor and a segment voice-over transcript;
for each new video segment of the one or more new video segments,
generating, based on the segment voice-over transcript for the new video segment, a voice-over segment, and
selecting, based on the segment descriptor for the new video segment, and from among the plurality of source video segments, a set of one or more source video segments for use in generating the new video segment; and
generating the new video, at least in part by inserting the generated voice-over segments for the one or more new video segments, and the selected sets of one or more source video segments for the one or more new video segments, in accordance with the sequential order.

14. The system of claim 13, wherein generating the script for the new video includes generating the script by inputting the source video to the generative AI engine.

15. The system of claim 14, wherein generating the script for the new video includes generating the script by inputting the source video and one or more user criteria to the generative AI engine, the one or more user criteria corresponding to requested characteristics of the new video.

16. The system of claim 15, wherein:
the one or more user criteria include a requested duration of the new video;
the script further includes, for each of the one or more new video segments, an estimated segment duration; and
generating the script includes determining the estimated segment durations for the one or more new video segments based on the requested duration.

17. The system of claim 13, wherein selecting the set of one or more source video segments for use in generating the new video segment includes inputting (i) at least a portion of the plurality of source video segments, (ii) the segment descriptor for the new video segment, and (iii) a prompt, to the generative AI engine.

18. The system of claim 17, wherein:
the script further includes, for each of the one or more new video segments, an estimated segment duration; and
selecting the set of one or more source video segments for use in generating the new video segment includes inputting (i) at least some of the plurality of source video segments, (ii) the segment descriptor for the new video segment, (iii) the prompt, and (iv) the estimated segment duration, to the generative AI engine.

19. The system of claim 13, wherein selecting the set of one or more source video segments for use in generating the new video segment includes:
generating embeddings for at least some of the plurality of segments;
generating an embedding for the segment descriptor for the new video segment; and
selecting the set of one or more source video segments based on the embeddings for the at least some of the plurality of segments and the embedding for the segment descriptor.

20. One or more non-transitory, computer-readable media storing instructions that, when executed by one or more processors, cause the one or more processors to perform operations comprising:
segmenting a source video into a plurality of source video segments;
generating, using a generative artificial intelligence (AI) engine comprising one or more generative AI models, a script for a new video, the script including, for each of one or more new video segments arranged according to a sequential order, a segment descriptor and a segment voice-over transcript;
for each new video segment of the one or more new video segments,
generating, based on the segment voice-over transcript for the new video segment, a voice-over segment, and
selecting, based on the segment descriptor for the new video segment, and from among the plurality of source video segments, a set of one or more source video segments for use in generating the new video segment; and
generating the new video, at least in part by inserting the generated voice-over segments for the one or more new video segments, and the selected sets of one or more source video segments for the one or more new video segments, in accordance with the sequential order.
